(19) United States
(12) Patent Application Publication
(10) Pub. No.: US 2006/0205896 A1
(43) Pub. Date: Sep. 14, 2006

(54) Epoxy resin composition for semiconductor sealing and semiconductor device

(75) Inventor: Atsunori Nishikawa, Utsunomiya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SUMITOMO BAKELITE CO., LTD., Shinagawa-ku (JP)

(21) Appl. No.: 11/368,596

(22) Filed: Mar. 7, 2006

(30) Foreign Application Priority Data
Mar. 10, 2005 (JP) 2005-068197

(51) Int. Cl. C08L 63/00

(52) U.S. Cl. 525/481

(57) ABSTRACT

An epoxy resin composition for sealing semiconductors including (A) an epoxy resin, (B) a phenol resin, (C) an inorganic filler, (D) a curing promoter, and (E) a surface-treated coloring agent, wherein the coloring agent before the surface treatment is a carbon precursor with a carbon content of 90 wt % or more or carbon black having a DBP absorption of 100 cm³/100 g or more, and a semiconductor device sealed with the epoxy resin composition. The epoxy resin composition can produce semiconductors which are free from electrical failures such as a short circuit, a leak current, and the like, do not induce wire deformation, and exhibits excellent laser marking characteristics.

### BACKGROUND OF THE INVETION

1. Field of the Invention

The present invention relates to an epoxy resin composition for semiconductor sealing and a semiconductor device using the epoxy resin composition.

2. Description of Related Art

Transfer molding of an epoxy resin composition is a suitable sealing method for low cost mass production of semiconductor devices such as ICs and LSIs. This method has been used for years, while its performance has been improved with respect to reliability through improvement of the epoxy resin and the phenol resin used as a curing agent. However, in the recent market trend aiming at miniaturization, weight reduction, and increased performance of electronic equipment, semiconductor devices have also become highly integrated and surface mounting technique has advanced year by year. This trend has increased requirements for the epoxy resin composition for semiconductor sealing. For these reasons, problems still to be solved in conventional epoxy resin compositions have come up.

Conventional semiconductor devices were sealed mainly with an epoxy resin composition containing carbon black used as a coloring agent in the composition, which shields semiconductor devices and provides distinct printing images of product names, lot numbers, and the like on the black background. More recently, an increasing number of electronic part manufacturers employ YAG laser markings which are more easily handled. As a method for improving the performance of YAG laser marking, Japanese Patent Application Laid-open No. 2-127449 discloses that carbon black having a carbon content of 99.5 wt % or more and a hydrogen content of 0.3 wt % or less is effective. There are various studies relating to this subject.

However, due to the fine pitch wiring in semiconductor devices in recent years, use of carbon black, which is a conductive coloring agent, induces electrical failures such as a circuit shortage and a leak current, when large particles of carbon black aggregates are present between inner leads or between wires. Moreover, if large particles of carbon black or the like are stuck in narrowed spaces between wires, the wires receive a stress which also causes failures of electrical properties. As a method for avoiding these electrical failures, Japanese Patent Application Laid-open No. 2004-263091 discloses use of an epoxy resin composition for semiconductor sealing comprising a coloring agent produced by oxidizing carbon black having a nitrogen adsorption specific surface area of 135 m²/g and a DBP absorption of 56 cm³/100 g. However, conventional epoxy resin compositions for semiconductor sealing containing carbon black treated by oxidation induce a wire shortage failure when the distance between wires is as small as 40 μm, although no such wire shortage problems occur at a wiring distance of 80 μm. An epoxy resin composition for semiconductor sealing exhibiting sufficient performance has not yet been developed.

Therefore, an objective of the present invention is to provide an epoxy resin composition for semiconductor sealing being free from electrical failures such as a short circuit, a leak current, and the like, not inducing wire deformation, and exhibiting excellent laser marking characteristics even if the distance between wires is as small as 40 μm, and to provide a semiconductor device using this epoxy resin composition.

### SUMMARY OF THE INVENTION

In view of this situation, the inventors of the present invention have conducted extensive studies. As a result, the inventors have found that an epoxy resin composition for semiconductor sealing comprising carbon black obtained by treating the surfaces of carbon black having DBP absorption of 100 cm³/100 g or more or carbon precursor obtained by treating the surfaces of carbon precursor with a carbon content of 90 wt % or more is free from electrical failures such as a short circuit, a leak current, and the like, does not induce wire deformation, and exhibits excellent laser marking characteristics even if the distance between wires is as small as 40 μm. This finding has led to the completion of the present invention.

Specifically, the present invention provides an epoxy resin composition for sealing semiconductors comprising (A) an epoxy resin, (B) a phenol resin, (C) an inorganic filler, (D) a curing promoter, and (E) a surface-treated coloring agent, wherein the coloring agent before the surface treatment is a carbon precursor with a carbon content of 90 wt % or more or carbon black having a DBP absorption of 100 cm³/100 g or more.

The present invention further provides the epoxy resin composition for sealing semiconductors, wherein the above surface treatment is an oxidation treatment. The present invention further provides the epoxy resin composition for sealing semiconductors, wherein water extracted from the surface-treated coloring agent (E) has a pH of 2 to 5. The present invention further provides the epoxy resin composition for sealing semiconductors, wherein the above surface treatment is an oxidation treatment using an acidic liquid containing one or more acids selected from the group consisting of a peroxodisulfate, hydrogen peroxide aqueous solution, sulfuric acid, nitric acid, hypochlorite, chloric acid, chlorous acid, and permanganate. The present invention further provides the epoxy resin composition for sealing semiconductors, wherein the above carbon black has a primary particle diameter of 40 to 90 nm. The present invention further provides the epoxy resin composition for sealing semiconductors, wherein the above carbon black has a nitrogen adsorption specific surface area of 20 to 100 m²/g. The present invention further provides the epoxy resin composition for sealing semiconductors, wherein the above carbon precursor has a specific resistance of 1×10² Ω·cm to 1×10⁷ Ω·cm. The present invention further provides the epoxy resin composition for sealing semiconductors, wherein the content of unsieved components when the surface-treated coloring agent (E) is sieved through a screen with openings of 25 μm is 0 wt %. The present invention further provides a semiconductor device sealed with any one of above epoxy resin compositions for semiconductor sealing.

Semiconductor devices sealed with the epoxy resin composition for semiconductor sealing of the present invention are free from electrical failures such as a short circuit, a leak current, and the like, do not induce wire deformation, and exhibit excellent laser marking characteristics, even with a small distance between wires of 40 μm.

### DETAILED DESCRIPTION OF THE INVENTION AND PREFERRED EMBODIMENT

The epoxy resin (A) used in the present invention is a monomer, an oligomer, or a polymer having two or more epoxy groups in one molecule. There are no specific limitations to the molecular weight and molecular structure. Examples include a biphenyl epoxy resin, bisphenol epoxy resin, stilbene epoxy resin, phenolnovolac epoxy resin, cresolnovolac epoxy resin, triphenolmethane epoxy resin, alkyl-modified triphenolmethane epoxy resin, triazine nucleus-containing epoxy resin, dicyclopentadiene-modified phenol epoxy resin, phenolaralkyl epoxy resin having a phenylene skeleton, biphenylene skeleton, or the like, sulfur atom-containing epoxy resin, and the like. These epoxy resins can be used either individually or in combination of two or more.

The phenol resin (B) used in the present invention is a monomer, an oligomer, or a polymer having two or more phenolic hydroxyl groups in one molecule. There are no specific limitations to the molecular weight and molecular structure of the phenol resin. Examples include a phenolnovolac resin, cresolnovolac resin, dicyclopentadiene-modified phenol resin, terpene-modified phenol resin, triphenolmethane resin, phenolaralkyl resin having a phenylene skeleton, biphenylene skeleton, or the like, sulfur atom-containing phenol resin, and the like. These phenol resins may be used either individually or in combination of two or more.

The amount the epoxy resin (A) and phenol resin (B) used in the composition of the present invention is preferably determined so that the ratio of epoxy groups in all epoxy resins to the phenolic hydroxyl groups in all phenol resins is from 0.8 to 1.3. A ratio in this range can prevent a decrease in curability of the epoxy resin composition or can suppress a decrease in the glass transition temperature, a decrease in the wet resistance reliability, or the like of the cured products.

As the inorganic filler (C), any inorganic fillers commonly used in epoxy resin compositions for semiconductor sealing can be used. As examples, molten silica, crystal silica, talc, alumina, silicon nitride, and the like can be given, with the most preferable inorganic filler being granular molten silica. These inorganic fillers may be used either individually or in combination of two or more. Although there are no specific limitations, the maximum particle diameter of the inorganic filler (C) is preferably 105 μm or less, more preferably 75 μm or less, and particularly preferably 55 μm or less, taking into account failures such as deformation of wires and the like that may occur when large particles of the inorganic filler are stuck in narrow spaces between the wires. Although there are no specific limitations, the amount of the inorganic filler (C) in the epoxy resin composition is preferably from 80 wt % to 94 wt %. The content of the inorganic filler (C) in this range can suppress a decrease in the solder resistance, flowability, and the like.

As the curing promoter (D), any curing promoters commonly used in epoxy resin compositions for semiconductor sealing can be used in the present invention. Examples include an addition product of a phosphine compound and a quinone compound, diazabicycloalkene and its derivatives such as 1,8-diazabicyclo(5,4,0)undecene-7, amine compounds such as tributylamine and benzyldimethylamine, imidazole compounds such as 2-methylimidazole, organic phosphines such as triphenylphosphine and methyldiphenylphosphine, tetra-substituted phosphonium tetra-substituted borate such as tetraphenylphosphonium tetraphenylborate, tetraphenylphosphonium tetrabenzoic acid borate, tetraphenylphosphonium tetranaphthoic acid borate, tetraphenylphosphonium tetranaphthoyloxyborate, tetraphenylphosphonium tetranaphthyloxyborate, and the like. These curing promoters may be used either individually or in combination of two or more.

The coloring agent for obtaining the surface-treated coloring agent (E) used in the present invention is a carbon precursor with a carbon atom content of 90 wt % or more or carbon black with a DBP absorption of 100 cm³/100 g or more.

The carbon precursor before surface treatment used as the coloring agent (E) has an H/C ratio by weight preferably of 2/97 to 8/90, and particularly preferably 2/97 to 6/93. The carbon precursor has a specific resistance preferably of 1×10² Ω·cm or more, but less than 1×10⁷ Ω·cm. A carbon precursor with a specific resistance of more than 1×10₇ Ω·cm or an H/C wt % ratio by weight of more than 8/90 is undesirable since such a carbon precursor has characteristics closer to an insulated material, in which the carbon precursor particles tend to reaggregate by a static charge and may cause deformation of gold wires during sealing. The H/C ratio by weight of 2/97 to 8/90 indicates that the carbon content and hydrogen atom content of the carbon precursor determined by elemental analysis are respectively 90 to 97 wt % and 2 to 8 wt %. The carbon precursor comprises fine particles with a primary particle diameter of about 2 to 5 nm.

The specific resistance can be determined using a known method, specifically, according to the method conforming to JIS Z3197. According to this method, after applying a flux to a G-10 or SE-4 substrate of an epoxy resin copper clad laminate on a glass fabric substrate having an wedge pattern, the pattern is soldered, and the resistivity is measured at 100 V DC using an ohm meter at 25° C. and 60% RH or less.

There are no specific limitations to the method for producing the carbon precursor of the present invention. One example of such a method comprises carbonizing an aromatic polymer such as a resole resin, phenol resin, or polyacrylonitrile at a firing temperature of 600 to 650° C. for an appropriate period of time. Either one type of carbon precursor or a mixture of two or more types of carbon precursors produced in this manner can be used.

Carbon black is suitable as a coloring agent for producing the coloring agent (E) from such viewpoints as coloring properties, shielding properties, heat resistance, and laser marking properties. A product obtained by oxidizing carbon black having a DBP absorption of 100 cm³/100 g or more before surface treatment contains primary carbon particles with a particles size in an appropriate range and contains only a small amount of aggregates of primary carbon particles before the surface treatment. Therefore, the surfaces of such carbon black can be treated in a state in which the substantial specific surface area is the maximum during the surface treatment. This is thought to be the reason why carbon particles after the treatment are most difficult to aggregate. When the primary particle size of the carbon black is too small, the oxidized product contains some amount of aggregates and has a DBP absorption of less than 100 cm³/100 g. Since the surfaces with a substantially reduced specific surface area are treated, the amount of surface treatment is decreased, resulting in a poor effect of surface treatment. When the primary particle size of carbon is large, on the other hand, the amount of aggregates is small, but the DBP absorption is less than 100 cm³/100 g. This necessitates a surface treatment of carbon black with a comparatively small specific surface area, with a consequence of a small amount of surface treatment and also a poor effect of surface treatment. The DBP absorption before the surface treatment may be 180 cm³/100 g or more, but the maximum amount should be less than about 200 cm³/100 g taking into account the relationship between the primary particle size and occurrence or non-occurrence of aggregation. For this reason, semiconductor devices sealed with an epoxy resin composition for semiconductor sealing containing a coloring agent produced by oxidizing the carbon black with such properties is free from electrical failures and wire deformation, even if the distance between wires is as small as 40 μm. When the DBP absorption is less than 100 cm³/100 g, sufficient dispersibility cannot be obtained. Carbon black having a primary particle diameter of 40 to 90 nm, carbon black having a nitrogen adsorption specific surface area of 20 to 100 m²/g, or carbon black having a primary particle diameter of 40 to 90 nm and a nitrogen adsorption specific surface area of 20 to 100 m²/g is preferable due to easy surface treatment and capability of reducing aggregates to the minimum.

The DBP absorption herein refers to the amount of DBP (dibutyl phthalate) required for filling voids of accumulated carbon black, which amount indicates the degree of structures in which particles are linked or aggregated. The primary particle diameter refers to an average diameter of small globules which constitute carbon black aggregates calculated based on measurement by electron microscope. The nitrogen adsorption specific surface area is a value used for measuring the total specific surface area of carbon black. The value is calculated from a specific surface area (m²/g), which is determined by immersing deaerated carbon black in liquid nitrogen and measuring the amount of nitrogen adsorbed on the surface of the carbon black in an equilibrium state. Commercially available products can be used as the coloring agent before surface treatment.

A preferred surface treatment applied to the component (E) in this invention is an oxidation treatment. As the method of oxidation treatment, a treatment using one or more acids selected from the group consisting of a peroxodisulfate, hydrogen peroxide aqueous solution, sulfuric acid, nitric acid, hypochlorite, chloric acid, chlorous acid, and permanganate is preferable. A common coloring agent before surface treatment is composed of very fine particles which are easily aggregated. These fine particles aggregate only with difficulty and exhibit excellent dispersibility, if the surfaces are treated. The oxidation treatment can cause hydroxyl groups and acidic groups such as a carboxylic acid group to be present on the surface of a coloring agent, thereby increasing affinity with a resin and allowing the coloring agent to aggregate only with difficulty.

Whether the coloring agent has been oxidized or not can be judged from the pH of extracted water. In more detail, the completion of oxidation can be judged by adding 5 g of the coloring agent to 50 g of purified water, heating the mixture in a pressure cooker at 125° C. for 24 hours, and measuring the pH of the supernatant liquid. In the present invention, the pH of water extracted from the coloring agent (E) after oxidation treatment is preferably from 2 to 5. Although there are no specific limitations, a wet process comprising dispersing a coloring agent in a solution containing an oxidizing agent is preferable as the oxidation method due to the capability of providing a uniform surface treatment. Use of a separation membrane such as an ultrafilter membrane is preferable to remove reduced salts generated by the oxidation treatment.

In the surface-treated coloring agent (E) of the present invention, the content of components that do not pass through a screen with openings of 25 μm (hereinafter referred to as “unsieved components”) is preferably 0 wt %. Fine particles, not limited to coloring agents, contain some amount of large and rough particles, which should be removed before use. For the sieving test, a method described in JIS K6218 (1997) entitled “test methods for other characteristics of carbon black for rubbers” is followed by using a screen with openings of 25 μm. Although not specifically limited, a method of dispersing the coloring agent in a solvent to produce a slurry, filtering the slurry through a filter with openings of 10 μm or less, drying the residue, and crushing the dried product can be given as a method for obtaining a coloring agent with 0 wt % unsieved components through a screen with openings of 25 μm. A surface treatment of the coloring agent in slurry conditions is preferable. A preliminary surface treatment of the coloring agent or addition of a surfactant to the solvent is more preferable to ensure good dispersion of the coloring agent in the solvent. The oxidation treatment is preferable in the present invention. Use of water as a solvent in the oxidation treatment is preferable due to the capability of excellently dispersing coloring agent and easily removing large and rough particles, and also in view of the low cost and safety of water. The slurry of coloring agent is dried by vacuum drying, hot air drying, or the like, and the resulting solid is crushed using a crusher such as a jet mill, a ball mill, or a Henschel mixer.

Although not specifically limited, the surface-treated coloring agent (E) is used in the present invention in an amount of 0.05 to 5 wt %, and more preferably 0.1 to 3 wt %, of the total amount of epoxy resin composition. The surface-treated coloring agent (E) in the amount of the above range ensures an excellent coloring effect and laser marking properties, and inhibits electrical failures, such as a short circuit and current leakage, and deformation of wires due to aggregation of the coloring agent.

A silane coupling agent can be optionally added to the epoxy resin composition of the present invention. Commonly known silane coupling agents such as epoxy silane, amino silane, alkyl silane, ureido silane, vinyl silane, and the like can be used. Specific examples include γ-aminopropyltriethoxysilane, γ-aminopropyltrimethoxysilane, N-β-(aminoethyl)-γ-aminopropyltrimethoxysilane, N-β-(aminoethyl)-γ-aminopropylmethyldimethoxysilane, N-phenyl-γ-aminopropyltriethoxysilane, N-phenyl-γ-aminopropyltrimethoxysilane, N-β-(aminoethyl)-γ-aminopropyltriethoxysilane, N-6-(aminohexyl)-3-aminopropyltrimethoxysilane, N-(3-(trimethoxysilylpropyl))-1,3-benzenedimethanane, γ-glycidoxypropyltriethoxysilane, γ-glycidoxypropyltrimethoxysilane, γ-glycidoxypropylmethyldimethoxysilane, β-(3,4-epoxycyclohexyl)ethyltrimethoxysilane, methyltrimethoxysilane, γ-ureidopropyltriethoxysilane, vinyltriethoxysilane, and the like. These silane coupling agents may be used either individually or in combination of two or more. Of these, secondary aminosilane and mercaptosilane are preferable. Although not specifically limited, the silane coupling agent is used in the present invention in an amount of 0.01 to 1 wt %, and more preferably 0.05 to 0.8 wt %, of the total amount of the epoxy resin composition. The content of the silane coupling agent in this range ensures good viscosity characteristics and excellent flowability, and can suppress deterioration of curability. These silane coupling agents may optionally be hydrolyzed by adding water and, as required, an acid or alkali or may be treated with an inorganic filler before using.

A compound having an aromatic ring in which two or more adjacent carbon atoms have hydroxyl groups bonded thereto can be optionally added to the epoxy resin composition of the present invention. As examples of such a compound, catechol, pyrogallol, gallic acid, gallic acid ester, 1,2-dihydroxynaphthalene, and 2,3-dihydroxynaphthalene, and derivatives of these compounds can be given. Of these, catechol, pyrogallol, 1,2-dihydroxynaphthalene, 2,3-dihydroxynaphthalene, and the like are preferable. These compounds may be used either individually or in combination of two or more. These compounds are added in an amount of 0.01 to 1 wt %, and more preferably 0.02 to 0.8 wt %, of the total amount of epoxy resin composition. The content of these compounds in this range ensures good viscosity characteristics and excellent flowability, and can suppress deterioration of curability and properties of cured products.

Because the compound having an aromatic ring in which two or more adjacent carbon atoms have hydroxyl groups bonded thereto can decrease viscosity and promote flowability of the composition by a synergistic effect with the silane coupling agent, this compound has an effect of suppressing a risk of large particles of carbon black aggregates being trapped between inner leads and also between wires.

A releasing agent can be optionally added to the epoxy resin composition of the present invention. A conventionally known releasing agent, for example, a higher fatty acid, metal salt of higher fatty acid, ester-type wax, polyethylene-based wax, and the like can be used. These releasing agents may be used either individually or in combination of two or more. Of these, polyethylene-based wax and montanic acid ester-type wax are preferable due to the excellent releasability and capability of preventing aggregation of coloring agents. Although not specifically limited, the releasing agent is added in an amount of 0.05 to 3 wt %, and more preferably 0.1 to 1 wt %, of the total amount of epoxy resin composition.

In the epoxy resin composition of the present invention, the epoxy resin, phenol resin, inorganic filler, curing promoter, and surface-treated coloring agent are essential components. The silane coupling agent, the compound having an aromatic ring in which two or more adjacent carbon atoms have hydroxyl groups bonded thereto, and the releasing agent are optionally added. Beside these components, additives such as an ion trapping agent such as a hydrotalcite and a hydroxyl group-containing compound of an element selected from magnesium, aluminum, bismuth, titanium, and zirconium, a coupling agent other than the silane coupling agent such as a titanate coupling agent, an aluminum coupling agent, or an aluminum/zirconium coupling agent, a low stress additive such as silicone oil and rubber, an adherence promoter such as thiazoline, diazole, triazole, triazine, and pyrimidine, a flame retardant such as a brominated epoxy resin, antimony trioxide, aluminium hydroxide, magnesium hydroxide, zinc borate, zinc molybdate, and phosphazene, and the like can be appropriately added.

The epoxy resin composition of the present invention can be produced by homogeneously mixing the above-mentioned raw materials using a mixer or the like, melting and kneading the mixture using a heating roller, a kneader, or the like, cooling the kneaded material, and crushing the resulting solid. As a method for producing semiconductors by sealing various electronic parts such as a semiconductor element using the epoxy resin composition of the present invention, a conventional molding and curing method such as transfer molding, compression molding, and injection molding can be used.

### EXAMPLES

The present invention will be described in more detail by examples, which should not be construed as limiting the present invention. In the examples and comparative examples, the amounts of the components are indicated by part(s) by weight. The following coloring agents, of which the surfaces are either treated or untreated, were used in the examples and comparative examples.

(Coloring Agent 1)

Carbon black having a DBP absorption of 142 cm³/100 g, a primary particle diameter of 60 nm, and a nitrogen adsorption specific surface area of 35 m²/g was surface-treated with an aqueous solution of sodium hypochlorite by a wet process. After the reduced salt was removed using an ultrafilter membrane, the carbon black was caused to pass through a 5 μm filter, dried at 110° C., and ground into fine particles using a jet mill. The extracted water had a pH of 2.8 and the amount of particles unsieved through a screen with openings of 25 μm was 0 wt %.

(Coloring Agent 2)

Carbon black having a DBP absorption of 105 cm³/100 g, a primary particle diameter of 42 nm, and a nitrogen adsorption specific surface area of 70 m²/g was surface-treated with an aqueous solution of sodium hypochlorite by a wet process. After the reduced salt was removed using an ultrafilter membrane, carbon black was caused to pass through a 5 μm filter, dried at 110° C., and ground into fine particles using a jet mill. The extracted water had a pH of 2.9 and the amount of particles unsieved through a screen with openings of 25 μm was 0 wt %.

(Coloring Agent 3)

Carbon black having a DBP absorption of 158 cm³/100 g, a primary particle diameter of 41 nm, and a nitrogen adsorption specific surface area of 57 m²/g was surface-treated with an aqueous solution of sodium hypochlorite by a wet process. After the reduced salt was removed using an ultrafilter membrane, carbon black was caused to pass through a 5 μm filter, dried at 110° C., and ground into fine particles using a jet mill. The extracted water had a pH of 2.8 and the amount of particles unsieved through a screen with openings of 25 μm was 0 wt %.

(Coloring Agent 4)

A carbon precursor having a carbon content of 96 wt %, a primary particle diameter of 3 nm, and a volume resistivity of 1×10⁶ Ω·cm was surface-treated with an aqueous solution of ammonium peroxidesulfate by a wet process. After the reduced salt was removed using an ultrafilter membrane, carbon black was caused to pass through a 10 μm filter, dried at 110° C., and ground into fine particles using a jet mill. The extracted water had a pH of 3.2 and the amount of particles unsieved through a screen with openings of 25 μm was 0 wt %.

(Coloring Agent 5)

Carbon black having a DBP absorption of 74 cm³/100 g, a primary particle diameter of 78 nm, and a nitrogen adsorption specific surface area of 28 m²/g was surface-treated with an aqueous solution of ammonium peroxidesulfate by a wet process. After the reduced salt was removed using an ultrafilter membrane, carbon black was caused to pass through a 5 μm filter, dried at 110° C., and ground into fine particles using a jet mill. The extracted water had a pH of 3.3 and the amount of particles unsieved through a screen with openings of 25 μm was 0 wt %.

(Coloring Agent 6)

The carbon black used for oxidation treatment to prepare the coloring agent 1. The extracted water had a pH of 6.8 and the amount of particles unsieved through a screen with openings of 25 μm was 0.003 wt %.

(Coloring Agent 7)

The carbon precursor used for the oxidation treatment to prepare the coloring agent 4. The extracted water had a pH of 6.2 and the amount of particles unsieved through a screen with openings of 25 μm was 0.036 wt %.

### Example 1

Epoxy resin 1, phenol resin 1, molten spherical silica 1, molten spherical silica 2, curing promoter 1, coloring agent 1, coupling agent 1, coupling agent 2,2,3-dihydroxynaphthalene, and a releasing agent in the proportion shown in Table 1 were mixed using a mixer and kneaded using a hot roller at 95° C. for 8 minutes. The kneaded material was cooled and crushed to obtain an epoxy resin composition. The epoxy resin composition obtained was evaluated according to the following methods of evaluation. The same composition as above, except for exclusion of the coloring agent 1, was mixed using a mixer and kneaded using a hot roller at 95° C. for 8 minutes. The kneaded material was cooled and crushed to obtain a sample for evaluation of a high temperature leakage examination, which is described later. The results of evaluation are shown in Table 1.

Epoxy resin 1 was a phenolaralkyl epoxy resin having a biphenylene skeleton of the following formula (1) (“NC3000P” manufactured by Nippon Kayaku Co., Ltd., softening point: 58° C., epoxy equivalent: 273).

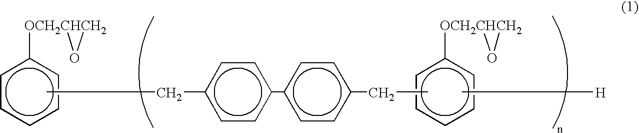

Phenol resin 1 was a phenolaralkyl resin having a biphenylene skeleton of the following formula (2) (“MEH-7851SS”, manufactured by Meiwa Plastic Industries, Ltd., softening point: 107° C., hydroxyl equivalent: 204).

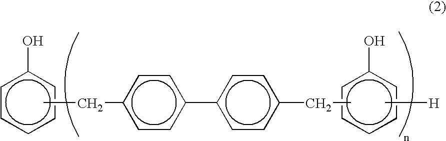

Molten spherical silica 1 has an average particle diameter of 23 μm, a maximum particle diameter of 75 μm, and a specific surface area of 3.5 m²/g, molten spherical silica 2 has an average particle diameter of 0.5 μm, a maximum particle size of 75 μm, and a specific surface area of 6.0 m²/g, curing promoter 1 is an addition product of triphenylphosphine and 1,4-benzoquinone, coupling agent 1 is N-phenyl-γ-aminopropyl trimethoxysilane (“KBM-573” manufactured by Shin-Etsu Chemical Co., Ltd.), coupling agent 2 is γ-mercaptopropyltrimethoxysilane (“KBM-803” manufactured by Shin-Etsu Chemical Co., Ltd.), 2,3-dihydroxynaphthalene is a reagent manufactured by Kanto Chemcal Co., Inc., and the releasing agent is montanic acid ester wax (“Licolub WE-4” manufactured by Clariant Japan, Ltd.).

<Evaluation Methods>

(Spiral Flow)

Using a low-pressure transfer molding machine, the die for measuring a spiral flow conforming to EMMI-1-66 was charged with the epoxy resin composition under the conditions of a die temperature of 175° C., injection pressure of 6.9 MPa, and curing time of 120 seconds to determine the flow distance.

(Curability)

Torque was measured using a curastometer (“JSR Curastometer IV PS-Type” manufactured by Orientec Inc.) at 175° C. The curability was indicated by a quotient obtained by dividing the torque measured after 60 seconds by the torque measured after 300 seconds. The larger the value, the better the curability.

(External Appearance (Color of Cured Product))

12 packages of 80pQFP (14×20×2.0 mm thickness) were prepared by forming the resin compositions using a low pressure transfer molding machine under the conditions of a die temperature of 175° C., injection pressure of 6.9 MPa, and curing time of 70 seconds. External appearance (color of the cured product) was inspected by visual observation.

(YAG Laser Marking Properties)

Some pieces of 80pQFP (thickness: 2.7 mm) were formed using a low pressure transfer molding machine under the conditions of a die temperature of 175° C., injection pressure of 6.9 MPa, and retention time of 120 seconds, followed by post-curing at 175° C. for 8 hours. Characters were printed by marking at a voltage of 2.4 kV and a pulse width of 120 μs using a mask type YAG laser seal machine (manufactured by NEC Corp.) to evaluate visibility of printing (YAG laser marking property). Samples with a good marking were indicated by “∘”, those with a usable marking were indicated as “Δ”, and those with an unusable marking were indicated as “x”.

(Evaluation of Aggregates)

A disk with a diameter of 100 mm was formed using a low pressure transfer molding machine under the conditions of a die temperature of 175° C., injection pressure of 6.9 MPa, and retention time of 120 seconds. The surface was ground and observed using a fluorescence microscope (“BX51M-53MF” manufactured by Olympus Corp.) to count the number of aggregates of coloring agent with a size of 25 μm or more.

(High temperature leakage)

100 pieces of 144pTQFP with gold wires, each having a diameter of 30 μm, bonded to three types of test chips, respectively having an interval of 80 μm, 60 μm, or 40 μm, were formed and sealed with the resin composition of Example 1 and the same resin composition as that of the Example 1, but not containing the coloring agent 1, using a low pressure transfer molding machine under the conditions of a die temperature of 175° C., injection pressure of 7.8 MPa, and retention time of 90 seconds. The leak current was measured using a microammeter “8240A” manufactured by Advantest Corp. High temperature leakage was evaluated by comparing the median value of leak current at 175° C. of the sample products with that of the comparative samples not containing the coloring agent 1. The results were indicated as “∘” when all sample products showed median values of the same order, as “Δ” when at least one sample product showed a one order (×10) higher median value, and as “x” when at least one sample product showed a two order (×10²) higher median value.

(Wire Deformation)

A package of 144pTQFP with gold wires, each having a length of 3 mm and a diameter of 25 μm, bonded to a test chip at intervals of 60 μm were formed and sealed using a low pressure transfer molding machine under the conditions of a die temperature of 175° C., injection pressure of 7.8 MPa, and retention time of 90 seconds. The wire sweep rate was measured using a soft X-ray apparatus “PRO-TEST-100” manufactured by Softex Corp. Sample products were rejected when the maximum wire sweep rate ((wire sweep amount/wire length)×100) was greater than 3%.

### Examples 2 to 5 and Comparative Examples 1 to 4

Epoxy resin compositions were prepared in the same manner as in Example 1 from the components shown in Table 1 and evaluated in the same manner as in Example 1. The results of evaluation are shown in Table 1. Epoxy resin 2 is a biphenyl epoxy resin (“YX-4000” manufactured by Japan Epoxy Resins Co., Ltd., epoxy equivalent: 190, melting point: 105° C.) shown by the following formula (3).

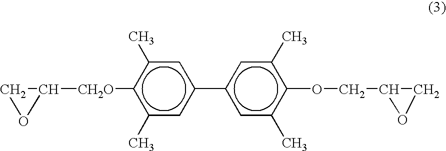

Phenol resin 2 is a phenolaralkyl resin (“XLC-LL” manufactured by Mitsui Chemicals, Inc., hydroxyl group equivalent: 165, melting point: 79° C.) shown by the following formula (4).

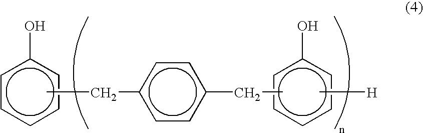

Curing promoter 2 is triphenylphosphine (“PP-360” manufactured by KI Chemical Industry Co., Ltd.).

TABLE 1

| | Example | | | | | Comparative Example | | | |
|---|---|---|---|---|---|---|---|---|---|
| | 1 | 2 | 3 | 4 | 5 | 1 | 2 | 3 | 4 |
| Epoxy resin 1 | 85 | 85 | 85 | 75 | 97 | 85 | | 85 | 75 |
| Epoxy resin 2 | | | | | | | 47 | | |
| Phenol resin 1 | 53 | 53 | 53 | 46 | 59 | 53 | | 53 | 46 |
| Phenol resin 2 | | | | | | | 41 | | |
| Molten spherical silica 1 | 750 | 750 | 750 | 750 | 730 | 750 | 800 | 750 | 750 |
| Molten spherical silica 2 | 100 | 100 | 100 | 100 | 100 | 100 | 100 | 100 | 100 |
| Curing promoter 1 | 3 | 3 | 3 | 3 | | 3 | 3 | 3 | 3 |
| Curing promoter 1 | | | | | 5 | | | | |
| Coloring agent 1 | 3 | | | | 3 | | | | |
| Coloring agent 2 | | 3 | | | | | | | |
| Coloring agent 3 | | | 3 | | | | | | |
| Coloring agent 4 | | | | 20 | | | | | |
| Coloring agent 5 | | | | | | 3 | 3 | | |
| Coloring agent 6 | | | | | | | | 3 | |
| Coloring agent 7 | | | | | | | | | 20 |
| Coupling agent 1 | 2 | 2 | 2 | 2 | 2 | 2 | 2 | 2 | 2 |
| Coupling agent 2 | 1 | 1 | 1 | 1 | 1 | 1 | 1 | 1 | 1 |
| 2,3-Dihydroxynaphthalene | 1 | 1 | 1 | 1 | 1 | 1 | 1 | 1 | 1 |
| Releasing agent | 2 | 2 | 2 | 2 | 2 | 2 | 2 | 2 | 2 |
| Spiral flow (cm) | 158 | 151 | 158 | 150 | 159 | 156 | 148 | 152 | 128 |
| Curability | 0.72 | 0.74 | 0.74 | 0.73 | 0.68 | 0.70 | 0.78 | 0.67 | 0.70 |
| Appearance (color of cured | ◯ | ◯ | ◯ | ◯ | ◯ | ◯ | ◯ | ◯ | ◯ |
| product) | | | | | | | | | |
| YAG laser marking | ◯ | ◯ | ◯ | Δ | ◯ | ◯ | ◯ | ◯ | Δ |
| properties | | | | | | | | | |
| Aggregates (number of | 0 | 0 | 0 | 8 | 0 | 2 | 1 | 43 | 100< |
| aggregated particles) | | | | | | | | | |
| High temperature leakage | ◯ | ◯ | ◯ | ◯ | ◯ | ◯ | ◯ | X | ◯ |
| (80 μm) | | | | | | | | | |
| High temperature leakage | ◯ | ◯ | ◯ | ◯ | ◯ | Δ | Δ | X | ◯ |
| (60 μm) | | | | | | | | | |
| High temperature leakage | ◯ | ◯ | ◯ | ◯ | ◯ | X | X | X | ◯ |
| (40 μm) | | | | | | | | | |
| Wire deformation | ◯ | ◯ | ◯ | ◯ | ◯ | ◯ | ◯ | ◯ | X |

Since the epoxy resin composition for semiconductor sealing obtained according to the present invention exhibits excellent flowability and curability during sealing of semiconductor devices and can produce semiconductor devices without electrical failures such as a short circuit, a leak current, and the like and not inducing wire deformation, the epoxy resin composition is particularly suitable for producing surface mounting-type semiconductors with a small distance between wires.

What is claimed is:

1. An epoxy resin composition for sealing semiconductors comprising (A) an epoxy resin, (B) a phenol resin, (C) an inorganic filler, (D) a curing promoter, and (E) a surface-treated coloring agent, wherein the coloring agent before the surface treatment is a carbon precursor with a carbon content of 90 wt % or more or carbon black having a DBP absorption of 100 cm³/100 g or more.

2. The epoxy resin composition for semiconductor sealing according to claim 1, wherein the surface treatment is an oxidation treatment.

3. The epoxy resin composition for sealing semiconductors according to claim 1 or 2, wherein water extracted from the surface-treated coloring agent (E) has a pH of 2 to 5.

4. The epoxy resin composition for sealing semiconductors according to any of claims 1 to 3, wherein the surface treatment is an oxidation treatment using an acidic liquid containing one or more acids selected from the group consisting of a peroxodisulfate, hydrogen peroxide aqueous solution, sulfuric acid, nitric acid, hypochlorite, chloric acid, chlorous acid, and permanganate.

5. The epoxy resin composition for sealing semiconductors according to any of claims 1 to 4, wherein the carbon black has a primary particle diameter of 40 to 90 nm.

6. The epoxy resin composition for sealing semiconductors according to any of claims 1 to 5, wherein the carbon black has a nitrogen adsorption specific surface area of 20 to 100 m²/g.

7. The epoxy resin composition according to any of claims 1 to 6, wherein the carbon precursor has a specific resistance of 1×10² Ω·cm to 1 ×10⁷ Ω·cm.

8. The epoxy resin composition for sealing semiconductors according to any of claims 1 to 7, wherein the content of unsieved components when the surface-treated coloring agent (E) is sieved through a screen with openings of 25 μm is 0 wt %.

9. A semiconductor device comprising a semiconductor element sealed using the epoxy resin composition according to any one of claims 1 to 8.
